(19) United States
(12) Patent Application Publication
(10) Pub. No.: US 2006/0256405 A1
(43) Pub. Date: Nov. 16, 2006

(54) Optical system and color wheel thereof

(75) Inventor: Kun-Yueh Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/407,194

(22) Filed: Apr. 20, 2006

(30) Foreign Application Priority Data
May 13, 2005 (TW) 094115561

(51) Int. Cl. H04N 1/46

(52) U.S. Cl. 358/512

(57) ABSTRACT

A color wheel includes at least two color filters and a light shielding piece. The light shielding piece is disposed between the color filters. The present invention also discloses an optical system including a color wheel and a lighting element. The color wheel includes at least two color filters and a light shielding piece disposed between the color filters. The lighting element generates a light source, which shoots to the color wheel to perform the light filtering.

### BACKGROUND OF THE INVENTION

1. Field of Invention

The present invention relates to an optical system and a color wheel, and more particularly to an optical system and a color wheel having a light shielding piece.

2. Related Art

Due to rapid development of technology, the type of information transmittance has been upgraded from analog to digital. In order to fit modern life style, video or image devices trend to thinner and lighter. Although conventional cathode ray tube (CRT) displays have some kinds of advantage, however they waste much space and are hard to be large-scaled because of the limitations of mechanical structure. Furthermore, CRT displays have an un-acceptable radiation issue. Accompanying to development of optical-electrical technology, an optical system such as liquid crystal projection system and optical array projection system has gradually accepted by market.

Within these major technologies, color wheel is one of important components. As shown in FIG. 1, conventional color wheel 1 includes a red (R) color filter 11, a green (G) color filter 12 and a blue (B) color filter 13. An optical beam 2 (as shown in dotted line) projects to the color wheel 1 that rotates for separating and filtering light colors by the red color filter 11, the green color filter 12 and the blue color filter 13. However, some disadvantages such as insufficient color saturation and brightness still exist.

Insufficient color saturation is caused not only by the effect of RGB color filters, but also by color mixing at the interface between different color filters.

It is therefore an important subject of the present invention to provide an optical system and a color wheel to solve above-mentioned problems, enhance filtering effect of color wheel and raise color saturation of optical system.

### SUMMARY OF THE INVENTION

In view of the foregoing, the present invention is to provide an optical system and a color wheel for raising color saturation.

To achieve the above, a color wheel according to the present invention includes at least two color filters and a light shielding piece. The light shielding piece is disposed between the color filters.

To achieve the above, an optical system according to the present invention includes a color wheel, a driving element and a lighting element. The color wheel includes at least two color filters and a light shielding piece disposed between the color filters. The driving element connects to the color wheel and drives the color wheel to rotate simultaneously. The lighting element generates a light source, which shoots to the color wheel to perform the light filtering.

To achieve the above, another optical system according to the present invention includes a color wheel, a light shielding wheel, a connecting element, a driving element and a lighting element. The color wheel includes at least two color filters. The light shielding wheel includes at least one light shielding piece and is disposed corresponding to the color wheel. The light shielding piece is disposed adjacent to the interface of the color filters. The connecting element connects to the color wheel and the light shielding wheel. The driving element connects to the color wheel and the light shielding wheel, and drives the color wheel and the light shielding wheel to rotate simultaneously. The lighting element generates a light source, and the color wheel and the light shielding wheel locate at a projection direction of the light source.

To achieve the above, a color filter device according to the present invention includes a color wheel, a light shielding wheel and a connecting element. The color wheel includes at least two color filters. The light shielding wheel is disposed corresponding to the color wheel, and the light shielding wheel includes at least one light shielding piece disposed adjacent to the interface of the color filters. The connecting element connects to the color wheel and the light shielding wheel, and drives the color wheel and the light shielding wheel to rotate simultaneously.

As mentioned above, due to the light shielding piece is disposed between or adjacent to the interface of different color filters, a color wheel according to the present invention will have no color mixing at the interface between different color filters. Therefore, an optical system and a color wheel according to the present invention may filter more pure three primary colors and raise color saturation of the optical system.

### BRIEF DESCRIPTION OF THE DRAWINGS

The present invention will become more fully understood from the detailed description given herein below illustration only, and thus is not limitative of the present invention, and wherein:

FIG. 1 is a schematic view showing a conventional color filter;

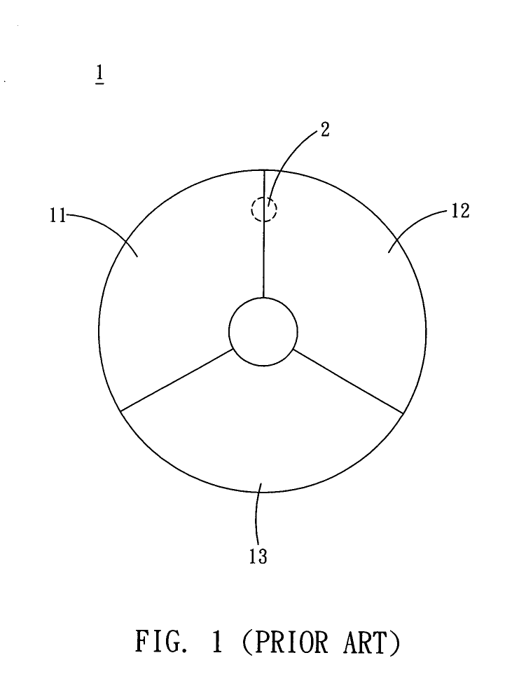

FIGS. 2A and 2B are schematic views showing a preferred embodiment of a color filter according to the present invention, wherein FIG. 2B is a cross-sectional view along line A-A′ in FIG. 2A;

FIG. 3 is a schematic view showing another preferred embodiment of a color filter according to the present invention;

FIG. 4 is a schematic view showing the first embodiment of an optical system according to the present invention;

FIGS. 5A to 5C are schematic views showing a light source shooting to a color wheel of an optical system according to the present invention;

FIG. 6 is a schematic view showing the second embodiment of an optical system according to the present invention;

FIGS. 7A and 7B are schematic views showing a color wheel and a light shielding wheel used in the second embodiment of an optical system according to the present invention; and

FIG. 7C is a schematic view showing another color wheel and light shielding wheel used in the second embodiment of an optical system according to the present invention.

### DETAILED DESCRIPTION OF THE INVENTION

The present invention will be apparent from the following detailed description, which proceeds with reference to the accompanying drawings, wherein the same references relate to the same elements.

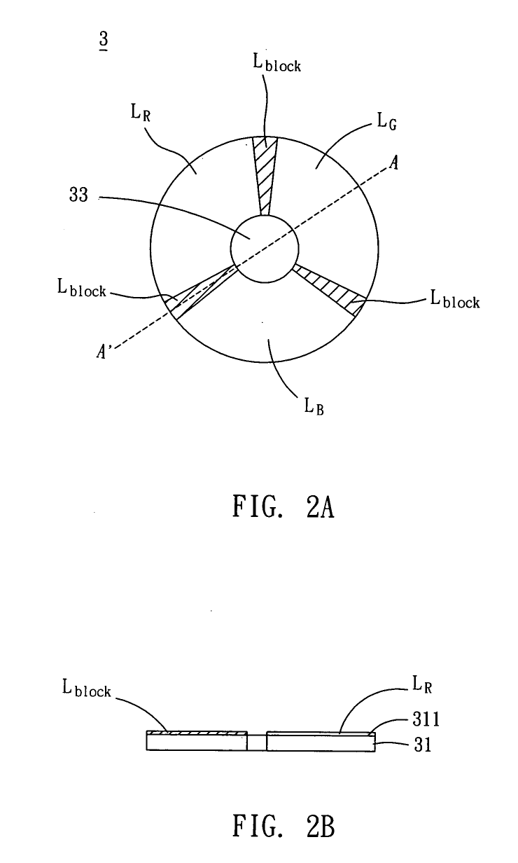

As shown in FIG. 2A, the preferred embodiment of a color wheel 3 according to the present invention includes three color filters L_{R}, L_{G}, L_{B} and a light shielding piece L_{block} disposed between the color filters.

In this embodiment, the color filters may be a red color filter L_{R}, a green color filter L_{G} and a blue color filter L_{B} respectively. The color filters connect together and form a disk structure. The light shielding piece L_{block} locates between the red color filter L_{R} and the green color filter L_{B} between the green color filter L_{G} and the blue color filter L_{B}, between the blue color filter L_{B} and between the red color filter L_{R} respectively. The color wheel 3 has an opening 33 at the center for applying to different types of system structure.

As shown in FIG. 2B, the color wheel 3 may further includes a substrate 31. The substrate 31 has a surface 311 and the color filters L_{R}, L_{G}, L_{B} and the light shielding piece L_{block} are disposed on the surface 311. Preferably, the substrate 31 is a transparent circular substrate and be made of glass.

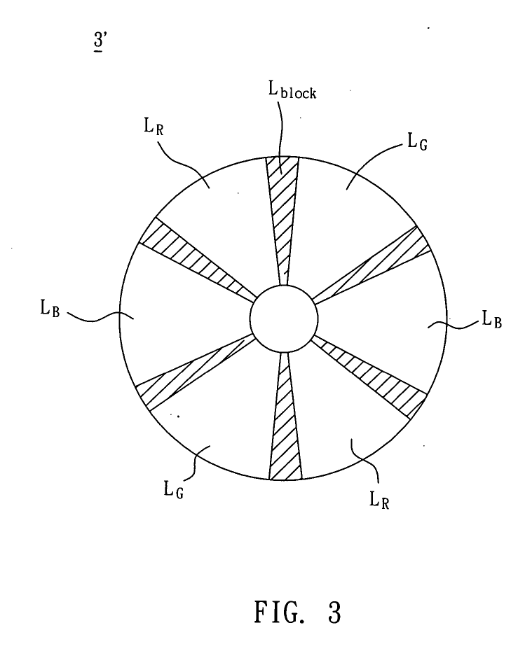

As shown in FIG. 3, the color wheel 3′ includes more than one red color filter L_{R}, more than one green color filter L_{G} and more than one blue color filter L_{B} in accordance with practical requirements in this embodiment. Besides, one or more than one white color filter may be included in the color wheel 3′ (not shown). A light shielding piece L_{block} is disposed between every two adjacent the color filters.

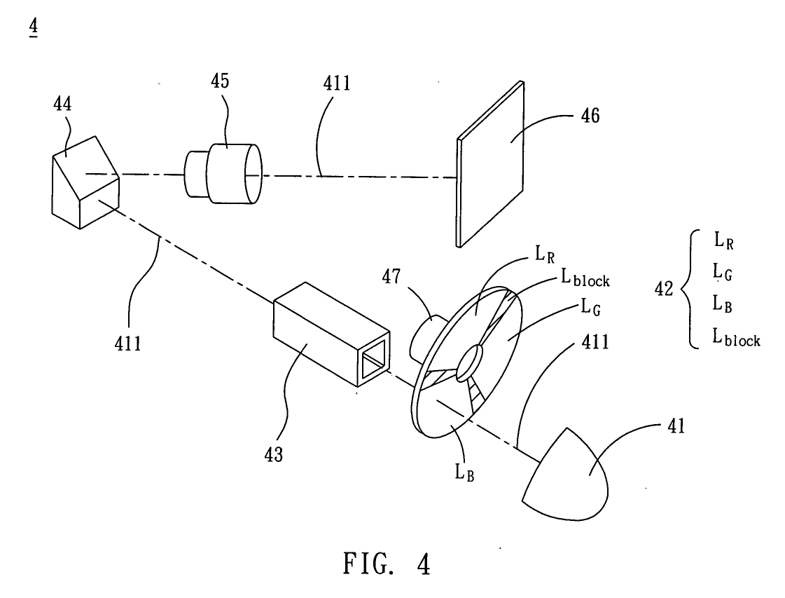

As shown in FIG. 4, the first embodiment of an optical system 4 according to the present invention includes a color wheel 42, a driving element 47 and a lighting element 41.

The color wheel 42 includes at least two color filters and a light shielding piece L_{block} disposed between the color filters. In this embodiment, the color filters may be a red color filter L_{R}, a green color filter L_{G} or a blue color filter L_{B} respectively. The color wheel 42 has the same construction and function as the above-mentioned color wheel 3. The corresponding descriptions are omitted for concise purpose.

The driving element 47 connects to the color wheel 42 and drives the color wheel 42 to rotate simultaneously. In this embodiment, the driving element 47 may be a motor.

The lighting element 41 generates a light source 411, which shoots to the rotating color wheel 42 to perform the light filtering by the red color filter L_{R}, the green color filter L_{G} or the blue color filter L_{B}.

In this embodiment, the optical system 4 further includes a reflecting element 44, a light-guiding element 43, a projecting element 45 and a display surface 46.

The light-guiding element 43 is disposed between the color wheel 42 and the reflecting element 44, which is used for light guiding and concentrating. Furthermore, the light-guiding element 43 may keep brightness to be an uniform distribution.

The projecting element 45 is disposed between the reflecting element 44 and the display surface 46. In this embodiment, the light source 411 passes through the light-guiding element 43 and shoots to the reflecting element 44, then be reflected to the projecting element 45. Finally, the light source 411 is projected to the display surface 46 by the projecting element 45.

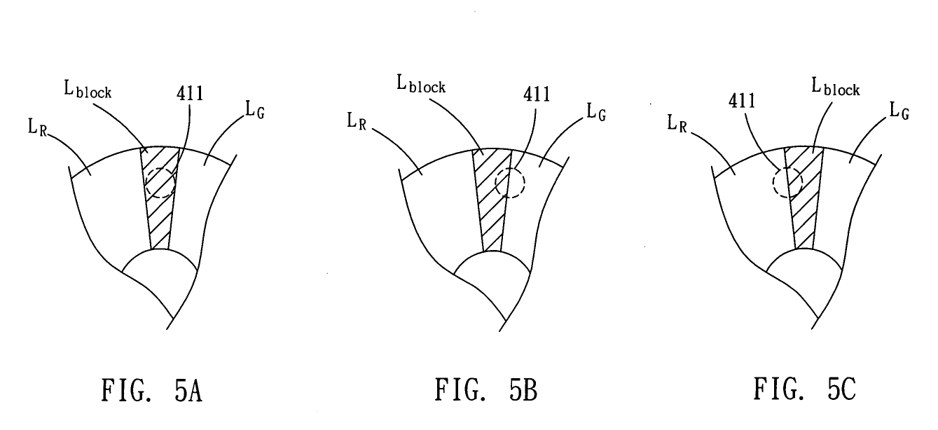

FIGS. 5A to 5C are schematic views showing the light source 411 shooting to the color wheel 42. As shown in FIG. 5A, circular periphery (shown in dotted circle) of the light source 411 shooting on the color wheel 42 is within both edges of the light shielding piece L_{block} in FIG. 5A. The circular periphery of the light source 411 shooting on the color wheel 42 is smaller than the width of the light shielding piece at the shooting point. As shown in FIGS. 5B and 5C, due to the light shielding piece L_{block} is disposed between the red color filter L_{R} and the green color filter L_{G}, the light source 411 only shoots on one color filter during the color wheel 42 is rotating. The problem of the light source shoots on over 2 color filters will be solved. There will be no color mixing at the interface between different color filters.

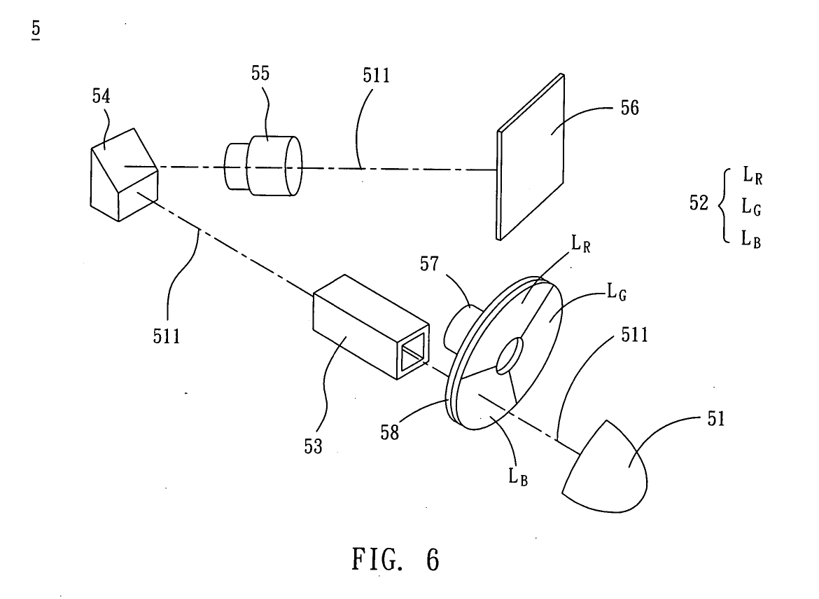

As shown in FIG. 6, the second embodiment of an optical system 5 according to the present invention includes a color wheel 52, a light shielding wheel 58, a connecting element (not shown) and a lighting element 51.

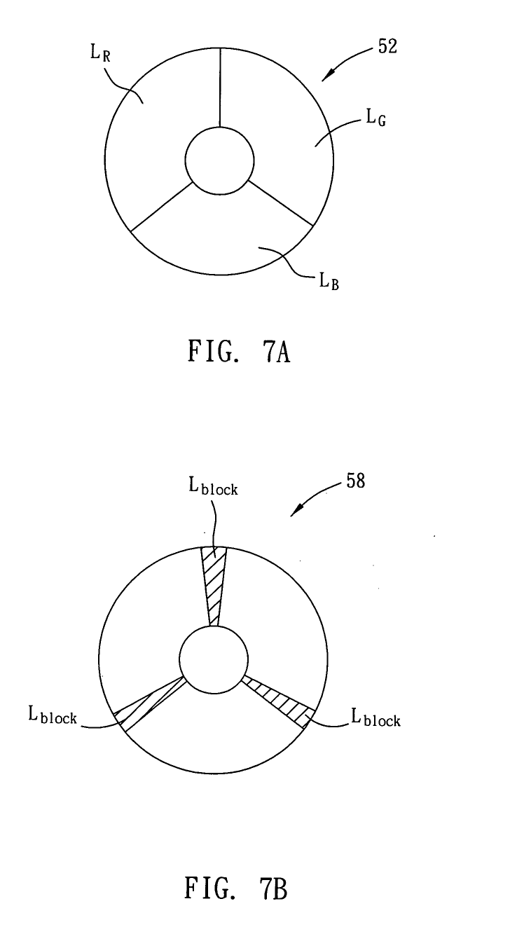

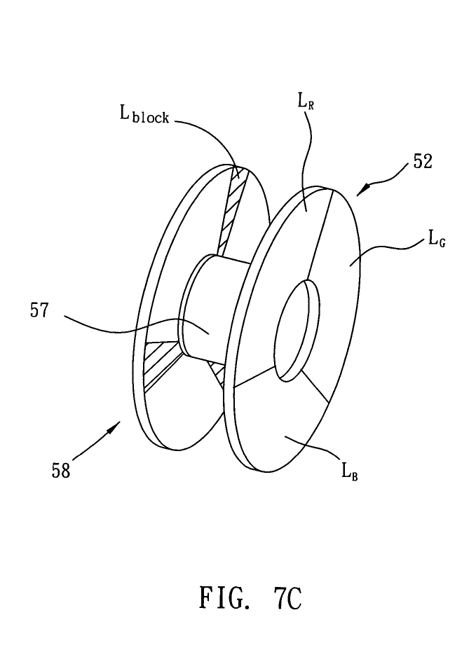

The color wheel 52 includes at least two color filters. In this embodiment, as shown in FIG. 7A, the color wheel 52 includes a red color filter L_{R}, a green color filter L_{G} and a blue color filter L_{B}.

As shown in FIG. 7B, The light shielding wheel 58 is disposed corresponding to the color wheel 52 and includes at least one light shielding piece L_{block} disposed adjacent to the interface of the color filters. In this embodiment, the light shielding wheel 58 includes three light shielding pieces L_{block} located adjacent to the interface of the red color filter L_{R} and the green color filter L_{G}, adjacent to the interface of the green color filter L_{G} and the blue color filter L_{B}, adjacent to the interface of the blue color filter L_{B} and between the red color filter L_{R} respectively.

The connecting element connects to the color wheel 52 and the light shielding wheel 58. In this embodiment, the connecting element may be an adhesive layer or a shaft.

The driving element 57 connects to the color wheel 52 and the light shielding wheel 58 and drives the color wheel 52 and the light shielding wheel 58 to rotate simultaneously. In this embodiment, the driving element 57 may be a motor.

The lighting element 51 generates a light source 511 and the color wheel 52 and the light shielding wheel 58 locate at a projection direction of the light source 511. In this embodiment, when the light source 511 shoots to the interface of different color filters of the color-wheel 52 and it will shoots to the light shielding pieces L_{block} of the light shielding wheel 58, then light mixing effect will be eliminated.

The color wheel 52, the light shielding wheel 58 and the driving element 57 may be constructed as shown in FIG. 7C. The color wheel 52 and the light shielding wheel 58 are disposed at both sides of the driving element 57 respectively. That is, the light shielding pieces L_{block} of the light shielding wheel 58 are disposed corresponding to the interface of different color filters of the color wheel 52. When the light source 511 shoots to the interface of different color filters of the color wheel 52 and it will shoots to the light shielding pieces L_{block} of the light shielding wheel 58, then light mixing effect will be eliminated.

As shown in FIG. 6, at the projection direction of the light source 511, the optical system 5 further includes a reflecting-element 54, a light-guiding element 53, a projecting element 55 and a display surface 56.

The reflecting element 54, the light-guiding element 53, the projecting element 55 and the display surface 56 have the same construction and function as those described in the first embodiment. The corresponding descriptions are omitted for concise purpose.

In summary, due to the light shielding piece is disposed between or adjacent to the interface of different color filters, a color wheel according to the present invention will have no color mixing at the interface between different color filters. Therefore, an optical system and a color wheel according to the present invention may filter more pure three primary colors and raise color saturation of the optical system.

Although the present invention has been described with reference to specific embodiments, this description is not meant to be construed in a pivoting sense. Various modifications of the disclosed embodiments; as well as alternative embodiments, will be apparent to persons skilled in the art. It is, therefore, contemplated that the appended claims will cover all modifications that fall within the true scope of the present invention.

What is claimed is:

1. A color wheel comprising:
at least two color filters; and
a light shielding piece disposed between the color filters.

2. The color wheel according to claim 1, further comprising a substrate for disposing the color filters and the light shielding piece thereon.

3. The color wheel according to claim 2, wherein the substrate is made of glass or a transparent material.

4. The color wheel according to claim 1, wherein the color filters are selected from the group consisting of red color filter, green color filter, blue color filter and white color filter.

5. The color wheel according to claim 1, wherein the light shielding piece is made of opaque material.

6. The color wheel according to claim 1, wherein the color wheel is used for an optical system which provides a light source, and circular periphery of the light source passed through the color wheel is within both edges of the light shielding piece.

7. An optical system comprising:
a color wheel comprising at least two color filters and a light shielding piece disposed between the color filters;
a driving element connecting to the color wheel and driving the color wheel to rotate; and
a lighting element for generating a light source to pass through the color wheel so as to perform the light filtering.

8. The optical system according to claim 7, wherein the color wheel further comprises
a substrate for disposing the color filters and the light shielding piece thereon.

9. The optical system according to claim 7, wherein the substrate is made of glass or a transparent material.

10. The optical system according to claim 7, further comprising
a reflecting element;
a light-guiding element disposed between the color wheel and the reflecting element; and
a projecting element disposed between the reflecting element and a display surface.

11. The optical system according to claim 7, wherein circular periphery of the light source passing through on the color wheel is within both edges of the light shielding piece.

12. A color filter device comprising:
a color wheel comprising at least two color filters;
a light shielding wheel disposed corresponding to the color wheel and comprising at least one light shielding piece disposed between of the color filters; and
a connecting element connecting to the color wheel and the light shielding wheel and driving the color wheel and the light shielding wheel to rotate.

13. The color filter device according to claim 12, wherein the connecting element is a shaft or an adhesive layer.

14. The color filter device according to claim 12, wherein the color wheel further comprises
a first substrate for disposing the color filters thereon; and
a second substrate for disposing the light shielding piece thereon.

15. The color filter device according to claim 14, wherein the transparent substrate is made of glass or a transparent material.

16. The color filter device according to claim 12, wherein the color filters are selected from the group consisting of red color filter, green color filter, blue color filter and white color filter; the light shielding piece is made of opaque material.

17. An optical system comprising:
a color wheel comprising at least two color filters;
a light shielding wheel disposed corresponding to the color wheel and comprising at least one light shielding piece disposed between the color filters;
a connecting element connecting to the color wheel and the light shielding wheel;
a driving element connecting to the color wheel and the light shielding wheel and driving the color wheel and the light shielding wheel to rotate; and
a lighting element for generating a light wherein the color wheel and the light shielding wheel are located at a projection direction of the light.

18. The optical system according to claim 17, wherein the connecting element is a shaft or an adhesive layer.

19. The optical system according to claim 17, wherein the color wheel further comprises
a first substrate, for disposing the color filters thereon; and
a second substrate for disposing the light shielding piece thereon.

20. The optical system according to claim 19, wherein the substrates are made of glass or a transparent material.

21. The optical system according to claim 17, wherein circular periphery of the light source shooting on the color wheel is within both edges of the light shielding piece.
